(19) United States
(12) Patent Application Publication
(10) Pub. No.: US 2011/0095626 A1
(43) Pub. Date: Apr. 28, 2011

(54) Hybrid Electret

(76) Inventors: Hsi-Hsin SHIH, Rende Township (TW); Che-I Kao, Rende Township (TW); Chien-Tsung Wu, Rende Township (TW); Po-Tsun Chen, Rende Township (TW)

(21) Appl. No.: 12/908,046

(22) Filed: Oct. 20, 2010

Related U.S. Application Data
(60) Provisional application No. 61/254,054, filed on Oct. 22, 2009.

(51) Int. Cl. B32B 27/00

(52) U.S. Cl. 307/400

(57) ABSTRACT

This invention discloses a hybrid electret. The hybrid electret comprises at least a first dielectric layer and at least a second dielectric layer, and the first dielectric layer and the second layer are alternatively stacked. The first dielectric layer comprises at least a polymer and the second dielectric layer comprises at least a polymer, and the polymer of the first dielectric layer differs from the polymer of the second dielectric layer.

This application is a non-provisional application of, and claims the benefit of priority from, the U.S. Patent Provisional Application No. 61/254,054 filed on Oct. 22, 2009, the contents of which are incorporated by reference.

### BACKGROUND OF THE INVENTION

1. Field of the Invention

The present invention relates to a hybrid electret. More particularly, the present invention relates to a hybrid electret constructed from at least two kinds of polymeric materials.

2. Description of the Prior Art

An electret is an electronic assembly for receiving charges and belongs to passive components, while working for blocking direct current, coupling alternating current, storing energy, coupling circuit, and storing charge and discharging. The dielectric material of a conventional electret is provided to prevent flow of direct current while allowing a limited amount of alternating current to pass therethrough. The dielectric material is typically made of ceramic powders and polymeric epoxy resin. The former with a high dielectric constant is not processable because the structure purely formed by ceramic powders is highly fragile. On the other hand, the polymeric material featuring its flexibility leads to a very low dielectric constant of the dielectric material. Therefore, commercially available electrets usually have their dielectric material formed by composites of polymeric and ceramic materials. As a modern trend of technical development, dielectric materials are mostly blends of polymeric epoxy resin and barium titanate. Because of the random arrangement at the dipole of barium titanate, the effects of dipole polarization can be offset.

Hence, how to make a hybrid electret and the dielectric material thereof remaining a high dielectric constant would be desired.

### SUMMARY OF THE INVENTION

In order to improve the aforementioned shortcomings, the present invention provides a hybrid electret. The hybrid electret comprises at least a first dielectric layer and at least a second dielectric layer, and the first dielectric layer and the second layer are alternatively stacked. The first dielectric layer comprises at least a polymer and the second dielectric layer comprising at least a polymer, and the polymer of the first dielectric layer differs from the polymer of the second dielectric layer.

Therefore, a primary objective of the present invention is to provide a hybrid dielectric layer that comprises at least two alternately stacking composite polymeric materials, contributing to enhance permittivity and enhance electric field effect.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic view of the hybrid electret of the preferred embodiment according to the present invention.

FIG. 2 is a sectional view of the hybrid electret of the preferred embodiment according to the present invention.

FIG. 3 is another sectional view of the hybrid electret of the preferred embodiment according to the present invention.

FIG. 4 demonstrates the percentage retention of the surface potentials of the testing sample of the hybrid electret and the control group at different time after being charged.

### DESCRIPTION OF THE PREFERRED EMBODIMENT

While the present invention discloses a kind of hybrid electret, the principle of electricity and manufacturing process technology of material adopted therein are known to people of ordinary skills in the art and need no to be fully explained in the following description. Meantime, the accompanying drawing referred by the following description intended to express structures related to the features of the present invention are not necessarily made to scale.

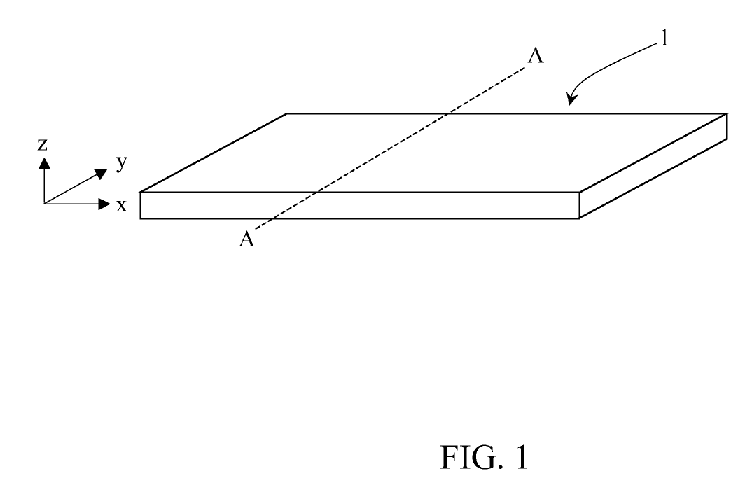

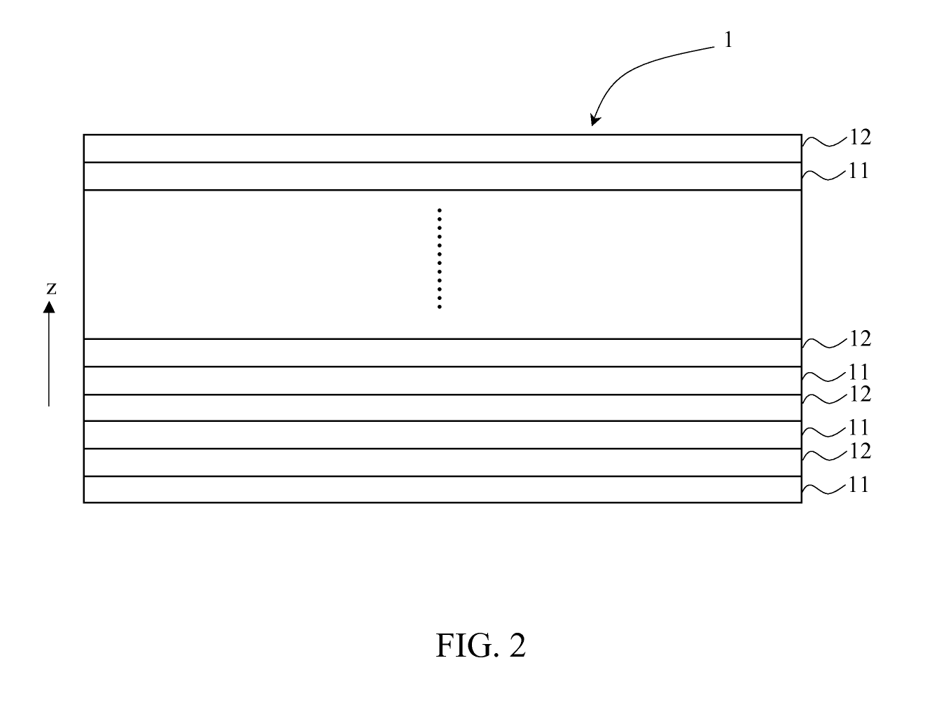

According to the objectives as described above, the present invention herein provides a first preferred embodiment. FIG. 1 is a schematic view of the hybrid electret of the preferred embodiment according to the present invention. FIG. 2 is a sectional view of the hybrid electret of the preferred embodiment according to the present invention. Referring to FIG. 1 and FIG. 2, in the preferred embodiment, a hybrid electret 1 comprises at least a first dielectric layer 11 and at least a second dielectric layer 12. The first dielectric layer 11 and the second dielectric layer 12 are alternately stacked. The first dielectric layer 11 comprises at least a polymer and the second dielectric layer 12 comprising at least a polymer, and the polymer of the first dielectric layer 11 differs from the polymer of the second dielectric layer 12. More specifically, the polymer of the first dielectric layer 11 is not compatible with the polymer of the second dielectric layer 12, which means that the polymer of the first dielectric layer 11 has a different solubility parameter or polarity value from that of the second dielectric layer 12. In addition, two polymers of different elasticity modulus or glass transition temperature also could be used to be polymers of the first dielectric layer 11 and the second dielectric layer 12 respectively, and the polymer of the first dielectric layer 11 has a first elastic modulus and the polymer of the second dielectric layer 12 has a second elastic modulus, and wherein the ratio value of the first elastic modulus to the second elastic modulus is from 1 to 6. During the manufacturing process, the polymer of the first dielectric layer 11 and the second dielectric layer 12 are not compatible with each other, which contributes to produce an apparent interface between the polymer of the first dielectric layer 11 and the polymer of the second dielectric layer 12. The structure in which the first dielectric layer 11 and the second dielectric layer 12 get “alternately stacked” may be with the layers stacked alternately in any one or two or in three of X, Y, Z axes thereof. For example, as shown in FIG. 2, which is a cross-sectional drawing taken along Line A-A of FIG. 1, the hybrid electret 1 has the layers stacked alternately in the Z axis. In the manufacturing method, the first dielectric layers 11 and the second dielectric layers 12 may each be made by, including but not limited to, blending, laminating, coating or extruding polymers that comprise them. Preferably, each of the first dielectric layer 11 and the second dielectric layer 12 has the thickness smaller than 500 nanometers, and more preferably, smaller than 200 nanometers.

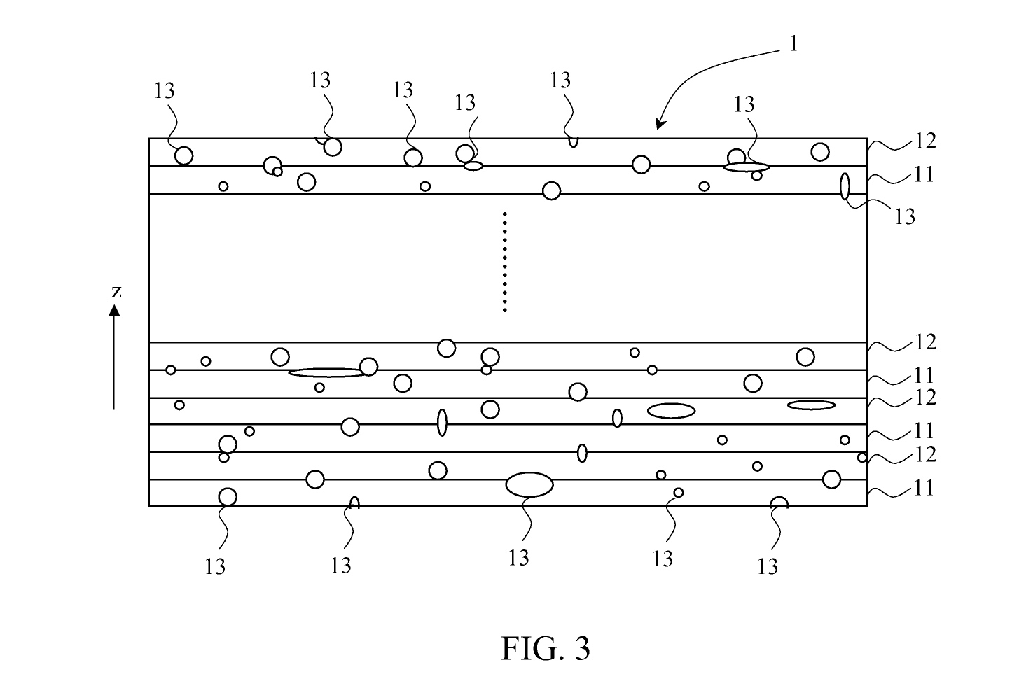

In addition, please refer to FIG. 3, the hybrid electret 1 may further comprise a porous structure 13. As shown in FIG. 3, the porous structure 13 may exists in the first dielectric layer 11 or the second dielectric layer 12, or exists between the first dielectric layer 11 and the dielectric layer 12. Moreover, the quantity of the pores of the porous structure 13 is more than one. The shapes of the porous structure 13 don't limited to shapes showed in the FIG. 3. The porous structure 13 can be various kinds of shapes.

The polymer of the first dielectric layer 11 or the dielectric layer 12 may be amorphous polymer, crystalline polymer, or polymer blend of the amorphous polymer and the crystalline polymer. The crystalline polymer can be polyolefin, nylon, or polyester. The amorphous polymer can be cyclic olefin copolymer, cycloalkyl olefin copolymer, aromatic olefin copolymer, polycarbonate, poly methyl methacrylate (PMMA), Glycol-Polyethylene Terephathalate (PETG, wherein the content of the cyclohexane dimethanol is less than 50%), or Polycyclohexylenedimethylene Terephthalate Glycol (PCTG, wherein the content of the cyclohexane dimethanol is more than 50%). In addition, the crystalline polymer has a first elastic modulus and the amorphous polymer has a second elastic modulus, and wherein the ratio value of the first elastic modulus to the second elastic modulus is from 1 to 6.

The polyolefin of the crystalline polymer can be polypropylene or polyethylene. The nylon can be nylon6 or nylon66. The polyester can be polyethylene terephthalate (PET) or polybutylene terephthalate (PBT).

The cyclic olefin copolymer of the amorphous polymer can be ethylene-norbornene copolymer, ethylene-dihydro dicyclopentadiene copolymer, ethylene-dicyclopentadiene copolymer, or ethylene-tetracyclododecene copolymer. The aromatic olefin copolymer can be polystyrene (PS), ethylene-phenyl norbornene copolymer, or Acrylonitrile-Butadiene-Styrene copolymer (ABS). The polycarbonate can be linear type polycarbonate or branch type polycarbonate.

Moreover, the polymer of the first dielectric layer 11 or the polymer of the second dielectric layer 12 may be copolymer or homopolymer. The kinds of the copolymer can be block copolymer, graft copolymer, random copolymer or alternating copolymer, and more preferably block copolymer. When the block copolymer is used, during the manufacturing process, a phase separation may therefore occur, and the phase separation may facilitate the production of the interfaces between the first dielectric layer 11 and the second dielectric layer 12, in the inside of the first dielectric layer 11 or the inside of the second dielectric layer 12. The permittivity and the electric field effect of the hybrid electret 1 are therefore enhanced.

According to the conception of the present invention, the first dielectric layer 11 and the second dielectric layer 12 may be made from the different polymers in ways including but not limited to:

(1) The polymer of the first dielectric layer 11 is an amorphous polymer, and the polymer of the second dielectric layer 12 is a crystalline polymer.

(2) The polymer of the first dielectric layer 11 is a crystalline polymer, and the polymer of the second dielectric layer 12 is an amorphous polymer.

(3) The polymer of the first dielectric layer 11 is a polymer blend of an amorphous polymer and a crystalline polymer, while the polymer of the second dielectric layer 12 is the crystalline polymer as used in the first dielectric layer 11.

(4) The polymer of the first dielectric layer 11 is a polymer blend of an amorphous polymer and a crystalline polymer, while the polymer of the second dielectric layer 12 is the amorphous polymer as used in the first dielectric layer 11.

(5) The polymers of the first dielectric layer 11 and the second dielectric layer 12 are both the polymer blend of the same amorphous polymer and the same crystalline polymer, but the ratio of the crystalline polymer to the total weight of the first dielectric layer 11 is different from that in the second dielectric layer 12. That is, the polymer of the first dielectric layer 11 and the second dielectric layer 12 are both the polymer blend of the same amorphous polymer and the same crystalline polymer, but blended in different proportions.

(6) The polymer of the first dielectric layer 11 is a first amorphous polymer, and the polymer of the second dielectric layer 12 is a second amorphous polymer. That is, the amorphous polymer of the first dielectric layer 11 is different from the amorphous polymer of the second dielectric layer 12.

(7) The polymer of the first dielectric layer 11 is a first amorphous polymer, and the polymer of the second dielectric layer 12 is a polymer blend of a second amorphous polymer and a second crystalline polymer. That is, the amorphous polymer of the first dielectric layer 11 is different from the amorphous polymer of the second dielectric layer 12.

(8) The polymer of the first dielectric layer 11 is a polymer blend of a first amorphous polymer and a first crystalline polymer, and the polymer of the second dielectric layer 12 is a second amorphous polymer. That is, the amorphous polymer of the first dielectric layer 11 is different from the amorphous polymer of the second dielectric layer 12.

(9) The polymer of the first dielectric layer 11 is a polymer blend of a first amorphous polymer and a first crystalline polymer, and the polymer of the second dielectric layer 12 is a second crystalline polymer. That is, the crystalline polymer of the first dielectric layer 11 is different from the crystalline polymer of the second dielectric layer 12.

(10) The polymer of the first dielectric layer 11 is a first crystalline polymer, and the polymer of the second dielectric layer 12 is a second crystalline polymer. That is, the crystalline polymer of the first dielectric layer 11 is different from the crystalline polymer of the second dielectric layer 12.

(11) The polymer of the first dielectric layer 11 is a first crystalline polymer, and the polymer of the second dielectric layer 12 is a polymer blend of a second amorphous polymer and a second crystalline polymer. That is, the crystalline polymer of the first dielectric layer 11 is different from the crystalline polymer of the second dielectric layer 12.

(12) The polymer of the first dielectric layer 11 is a polymer blend of a first crystalline polymer and a first amorphous polymer, and the polymer of the second dielectric layer 12 is a polymer blend of a second amorphous polymer and a second crystalline polymer. That is, the crystalline polymer of the first dielectric layer 11 is different from the crystalline polymer of the second dielectric layer 12, as well as the amorphous polymer of the first dielectric layer 11 is different from the amorphous polymer of the second dielectric layer 12.

As described in the above twelve situations, the first dielectric layer 11 or the second dielectric layer 12 (or both) may further blends with an organic filler or an inorganic filler. The organic filler can be polystyrene or polypropylene, and the inorganic filler can be silicon dioxide, titanium dioxide, or calcium carbonate. In the same layer, the ratio value of the modulus elasticity of the organic (or inorganic) filler to that of the crystalline (or amorphous) polymer preferably ranges from 50 to 600.

Moreover, the results of following experiments demonstrate the effects and outcomes of the present invention.

### Experiments:

1. Manufacturing of the Testing Sample

(1) Manufacturing of the Testing Sample of the Hybrid Electret

First, polycarbonate and poly methyl methacrylate are separately melt and extruded by individual extruder respectively. Later, during extrusion, the polycarbonate and poly methylmethacrylate turn from solid into liquid state and become two polymer melts. The two polymer melts then joined together in a feed block or in a die and form a single structure with multiple layers. Polycarbonate and polymethyl methacrylate layers are alternately stacked and each layer has the same thickness. Therefore, the film sample of the hybrid electret that has an alternately stacking multilayered structure is made. After that, a 6 millimeter (mm)×6 millimeter (mm) piece is cut and formed with an electrode at the backside thereof to be the testing sample. The testing sample is flattened as much as possible.

(2) Manufacturing of the Testing Sample of the Control Group

Feeding polycarbonate and poly methyl methacrylate with a volume ratio of 1:1 into a twin screw extruder, followed by premixed in 240° C. to increase the homogeneity. Later, the premixed material is fed into a film extruder and extruded in 240° C. as well. The thickness of the extruded film is controlled to be substantially the same as the film sample of the hybrid electret mentioned previously. Therefore, the film sample of the control group of single-layered structure is made. After that, a 6 mm×6 mm piece is also cut and formed with an electrode at the backside thereof to be the testing sample. The testing sample is flattened as much as possible.

2. Measuring of the Charge-Storage Capability

The two testing sample of the hybrid electret and the single-layered control group manufactured as described previously are put below a charging needle at a distance of 1 millimeter (mm). The charging needle is in alignment with the centre of the testing sample. A direct current of −3 kilovolts (kV) is applied to the testing sample for 60 seconds continuously.

The testing sample after being charged is put into a fixture and the ambient temperature is controlled in a range of 24˜26° C. and the relative humidity is controlled in a range of 35˜50%. The surface potential of the testing sample is measured by voltage-meter initially. For next every 24±1 hours, the surface potential of the testing sample at the first, second, third, fourth, and tenth day of the experiment are measured and recorded.

3. Result of Measuring

The surface potential of the testing sample and the respecting percentage retention of the surface potential at the first, second, third, fourth, fifth and tenth day of the experiment of the two testing sample tested in ways as described previously are shown in Table 1.

TABLE 1
The surface potential of the testing sample and the respecting percentage
retention of the surface potential at different time.

| Day of the experiment | | initial | 1 | 2 | 3 | 4 | 10 |
|---|---|---|---|---|---|---|---|
| Hybrid | Surface | −1.45 | −0.14 | −0.08 | −0.08 | −0.08 | −0.04 |
| electret | potential (kV) | | | | | | |
| | Percentage | — | 9.66% | 5.52% | 5.52% | 5.52% | 2.76% |
| | retention (%) | | | | | | |
| Control | Surface | −0.76 | 0 | 0 | 0 | 0 | 0 |
| group | potential (kV) | | | | | | |
| | Percentage | — | 0% | 0% | 0% | 0% | 0% |
| | retention (%) | | | | | | |

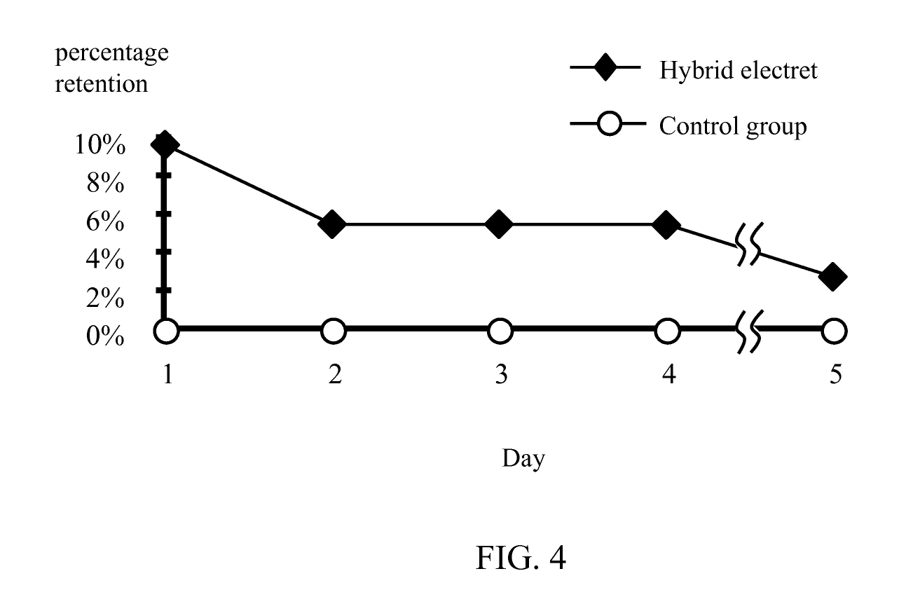

As shown in Table 1 and FIG. 4, after being charged (initial), the surface potential of the testing sample of the hybrid electret is −1.45 kilovolts (kV), whereas the testing sample of the control group is −0.76 kilovolts (kV). Therefore, the testing sample of the hybrid electret of the present invention has a better charge-storage capability (permittivity) than the single-layered control group.

In addition, at the first day of the experiment, the percent retention of the surface potential of the single-layered control group is 0%. On the contrary, the surface potential of the testing sample of the hybrid electret is not reduced to zero until the 10th day of the experiment. The respective percent retention is 9.66% at the first day, 5.52% at the second day, 5.52% at the third day, 5.52% at the fourth day and 2.76% at the 10th day. That is, the hybrid electret surprisingly retains significant fraction of the charge over many days. The respective surface potential is −0.14 kV at the first day, −0.08 kV at the second day, −0.08 kV at the third day, −0.08 kV at the fourth day, and −0.04 kV at the 10th day. Therefore, when compared with the single-layered control group, the test sample of the hybrid electret has a better charge-storage capability.

According to the above-mentioned results, when compared with the ordinary single-layered film, the hybrid electret of the present invention that has an alternately stacked multilayered structure has a better charge-storage capability (permittivity) and a better electric field effect.

The present invention can also be implemented by or applied in other embodiments, where changes and modifications can be made to the disclosed details from a viewpoint different from that adopted in this specification without departing from the spirit of the present invention.

What is claimed is:

1. A hybrid electret comprising at least a first dielectric layer and at least a second dielectric layer, wherein
the first dielectric layer and the second dielectric layer are alternatively stacked;
the first dielectric layer comprises at least a polymer and the second dielectric layer comprising at least a polymer; and
the polymer of the first dielectric layer differs from the polymer of the second dielectric layer.

2. The hybrid electret of claim 1, wherein the polymer of the first dielectric layer is not compatible with the polymer of the second dielectric layer.

3. The hybrid electret of claim 1, wherein the first dielectric layer and the second dielectric layer are made of materials selected from the group consisting of a crystalline polymer and an amorphous polymer.

4. The hybrid electret of claim 1, wherein the polymer of the first dielectric layer is an amorphous polymer and the polymer of the second dielectric layer is a crystalline polymer.

5. The hybrid electret of claim 1, wherein the polymer of the first dielectric layer is a polymer blend of an amorphous polymer and a crystalline polymer, and the polymer of the second dielectric layer comprises the crystalline polymer or the amorphous polymer of the polymer blend.

6. The hybrid electret of claim 1, wherein the first dielectric layer and the second dielectric layer comprises polymer blends of an amorphous polymer and a crystalline polymer, and wherein the polymer blends of the first dielectric layer and the second dielectric layer have different volume ratio of amorphous polymer and crystalline polymer.

7. The hybrid electret of claim 3, wherein the crystalline polymer is selected from the group consisting of polyolefin, nylon and polyester.

8. The hybrid electret of claim 3, wherein the amorphous polymer is selected from the group consisting of cyclic olefin copolymer, cycloalkyl olefin copolymer, aromatic olefin copolymer, and polycarbonate.

9. The hybrid electret of claim 1, wherein the polymer of the first dielectric layer is selected from the group consisting of a first crystalline polymer and a first amorphous polymer, and the polymer of the second dielectric layer is selected from the group consisting of a second crystalline polymer and a second amorphous polymer.

10. The hybrid electret of claim 3, wherein the first dielectric layer or the second dielectric layer further blends with an organic filler or an inorganic filler.

11. The hybrid electret of claim 1, wherein the polymer of the first dielectric layer or the second dielectric layer is a copolymer.

12. The hybrid electret of claim 1, further comprises a porous structure.

13. The hybrid electret of claim 1, wherein the polymer of the first dielectric layer has a first elastic modulus and the polymer of the second dielectric layer has a second elastic modulus, and wherein the ratio value of the first elastic modulus to the second elastic modulus is from 1 to 6.

14. The hybrid electret of claim 3, wherein the crystalline polymer has a first elastic modulus and the amorphous polymer has a second elastic modulus, and wherein the ratio value of the first elastic modulus to the second elastic modulus is from 1 to 6.

15. The hybrid electret of claim 10, wherein the ratio value of the modulus elasticity of the organic or inorganic filler to that of the crystalline or amorphous polymer ranges from 50 to 600.

16. The hybrid electret of claim 1, wherein the first dielectric layer and the second dielectric layer each has a thickness ranges from 10 nm to 500 nm.

17. The hybrid electret of claim 1, wherein the first dielectric layer and the second dielectric layer each has a thickness ranges from 10 nm to 200 nm.
